(19) United States
(12) Patent Application Publication
(10) Pub. No.: US 2018/0244428 A1
(43) Pub. Date: Aug. 30, 2018

(54) BARREL FOR CARBON DIOXIDE CONTAINING DRINKS AND USE THEREOF

(71) Applicant: CARDIFF GROUP, NAAMLOZE VENNOOTSCHAP, Zonhoven (BE)

(72) Inventors: Geert Norbert R. STANDAERT, Zonhoven (BE); Imar VANDEBRIEL, Hechtel (BE)

(21) Appl. No.: 15/549,572

(22) PCT Filed: Feb. 8, 2016
(86) PCT No.: PCT/BE2016/000012

§ 371 Date: Aug. 8, 2017

(30) Foreign Application Priority Data
Feb. 10, 2015 (BE) 2015/5067

(51) Int. Cl. B65D 8/02; B32B 5/02; B32B 1/02; B32B 27/12; B32B 27/32; B65D 85/72; B65D 77/06; C12C 11/11

(52) U.S. Cl. CPC B65D 11/08; B29C 45/14786; B32B 1/02; B32B 27/12; B32B 27/32; B65D 85/72; B65D 77/06; C12C 11/11; B32B 2260/021; B32B 2260/046; B32B 2323/04; B32B 2262/101; B32B 2323/10; B32B 2439/40; B32B 2439/70; B32B 2307/7244; B32B 5/02

(57) ABSTRACT

Disclosed is a barrel for CO₂-containing drinks. The barrel includes a rigid holder that includes at least two layers, i.e. a first layer that is made of a polymer and a second, fibre-reinforced, layer, whereby the second layer is outside the first layer and whereby the second layer is attached to the first layer.

The present invention relates to a barrel for CO₂-containing drinks and the use thereof.

More specifically the invention relates to a barrel or keg for beer, in which the beer can be placed under pressure and from which the beer can be dispensed.

Such a beer barrel must satisfy a number of technical requirements. Firstly the beer must be well separated from the outside air in order to prevent CO₂ being able to escape from the beer whereby the flavour of the beer would change, and also to prevent oxygen from the air being able to get into the beer, because this too can detrimentally affect the flavour to a great extent. For example, depending on the type, even an oxygen content of 1000 ppb (parts per billion) can be harmful for the flavour.

Such a separation from the outside air is important both before the beer is used for the first time and after a part of the beer has already been tapped off, but a proportion to be used in the future is still present in the barrel.

The extent to which a beer barrel satisfies these technical requirements depends on the gas permeability of the various walls that are used in the beer keg, whereby walls with a higher diffusion barrier in general cost more because they are thicker or made of a more expensive material.

Secondly, the holder has a mechanical function, i.e. to resist the internal pressure, without deformation or damage, that is necessary to dispense the foodstuff out of the holder.

This pressure can be high, certainly in barrels in which the pressure medium, for example CO₂, for driving out the beer is already present when these barrels are in a warm environment, which can easily happen during the transport of the filled barrels. In certain conditions this pressure can amount to 10 bar. It must also be considered that such barrels can fall during transport, and can thereby be exposed to high forces from the outside.

It goes without saying that such beer kegs must be constructed as cheaply as possible, such that current metal barrels are considered too expensive and heavy, certainly in cases where the transport distance is relatively long and/or good coordination of the supply chain is lacking, such that reuse is difficult.

Beer barrels of polypropylene or polyethylene are known. However they have a limited resistance to high pressure, so that at higher pressures in particular they must be constructed with very thick walls.

Also during use, the pressure resistance falls quickly, because with every significant change in pressure, such as during a temporary higher temperature for example, as mentioned above, but also the repressurisation for reuse, a partially elastic and partially irreversible plastic deformation occurs that can lead to risky weak spots after reuse a few times.

These materials are also relatively permeable to CO₂ and oxygen, so that special measures have to be taken to screen off the beer.

US2013/105501 describes a method for producing a leak-tight vessel for holding a gas and/or liquid, the gas and/or liquid tight layer, thereby leaving an opening large enough for removing the mandrel.

US2010/018994 describes a container, or keg, for storing, shipping, and dispensing a bulk quantity of a fluid, for example, beer or like malt beverage. The container/keg includes a flaccid bag for containing the fluid and a substantially rigid, pressure-tight, plastic vessel within which the bag is contained.

Currently no beer barrels are known that are cheap, have good CO₂ and oxygen protection, are resistant to high pressures, and can also be recycled dozens of times.

The purpose of the present invention is to provide a solution to the aforementioned and other disadvantages by providing a barrel for CO₂-containing drinks, whereby the barrel comprises a rigid holder that comprises at least two layers, i.e. a first layer that is made of a polymer and a second, fibre-reinforced, layer, whereby the second layer is outside the first layer and whereby the second layer is attached to the first layer.

Such a barrel is cheap to produce and is highly suitable for resisting high pressures.

Thanks to the second layer, which cannot expand, and the good attachment between the first and second layer, plastic deformation of the first layer does not occur, so that the barrel can be reused repeatedly. Hereby the second layer can be affixed over the entire first layer, but the second layer can also be an incomplete second layer that is only affixed in places where the risk of rupture is the greatest.

In a preferred embodiment the barrel also comprises a flexible holder that is inside the rigid holder.

Preferably the rigid holder comprises a first outlet and the flexible holder comprises a second outlet, whereby the second outlet is provided with a connecting piece that is connected to the first outlet, and whereby the connecting piece is also provided with a tap or a connection for a tap.

The flexible holder can now be filled with a CO₂-containing drink, and the space between the rigid holder and the flexible holder with a pressure medium, so that due to the compression of the flexible holder the drink can be driven out of the barrel.

In another preferred embodiment the barrel is provided with a barrier layer to prevent the diffusion of oxygen from the outside to the inside and the diffusion of CO₂ from the inside to the outside.

This can be done by providing the first or second layer, or the interface between the two, with a barrier layer, for example a thin metal layer.

As is known from WO 2012/167333, for example, this can be done by using two flexible holders placed in one another, whereby the inner flexible holder is intended to contain the drink and the outer flexible holder is intended to be pushed against the inside of the rigid holder by the pressure medium, and as a result reduces the permeability of the rigid holder for the pressure medium, and whereby one or both of these flexible holders are made of a barrier material for CO₂ and oxygen.

In a further preferred embodiment the first layer is essentially made of an injection-mouldable polymer, preferably polyethylene that can be both HDPE and LDPE, or polypropylene. As a result this first layer is cheap to produce by means of injection moulding.

Furthermore, the said plastics have the advantage that even if the pressure rises higher than what the barrel can deal with, the barrel will not explode, but will plastically deform and tear locally, so that the pressure is reduced in a relatively controlled way so that a potentially hazardous explosion is prevented.

In a preferred embodiment the second layer is provided with one or more reinforcing fibres that are wound around the first layer. This means that the reinforcing fibres concerned each run completely around the barrel at least once.

Preferably there is or are only one or a few long reinforcing fibres that run repeatedly around the barrel.

As a result the resistance of the barrel to pressure from the inside is better, because the reinforcing fibres have a high tensile strength.

Hereby the reinforcing fibres are preferably embedded in a binder, whereby the binder is preferably polypropylene or polyethylene. Thanks to the binder a good attachment to the first layer is obtained.

In a further preferred embodiment the barrel is provided with a third layer that is made of plastic, whereby the third layer is outside the second layer.

Such a third layer is used to protect the first and second layer against impacts and other possible damage from the outside. As a result a shape can also be given to the barrel that enables a stable placement on a surface and also a stable stacking of the barrels, which would be difficult or even impossible if the second, fibre-reinforced, layer is the outside layer.

The third layer also has a decorative function.

The third layer is preferably made of polyethylene or polypropylene by means of injection moulding.

The third layer can be attached to the second layer, but preferably the third layer is not attached to the second layer and is made of two or more parts that are detachably fastened together.

This means that the third layer, in the form of a shell, is easy to affix and also easy to replace in the event of damage. Such damage is to be expected, certainly in view of the reusability of the barrels, because such barrels are moved a lot and thereby can easily be knocked or fall.

The invention further concerns the use of a barrel as described above for storing CO₂-containing drinks, in particular beer.

With the intention of better showing the characteristics of the invention, a preferred embodiment of a barrel according to the invention is described hereinafter by way of an example, without any limiting nature, with reference to the accompanying drawings, wherein:

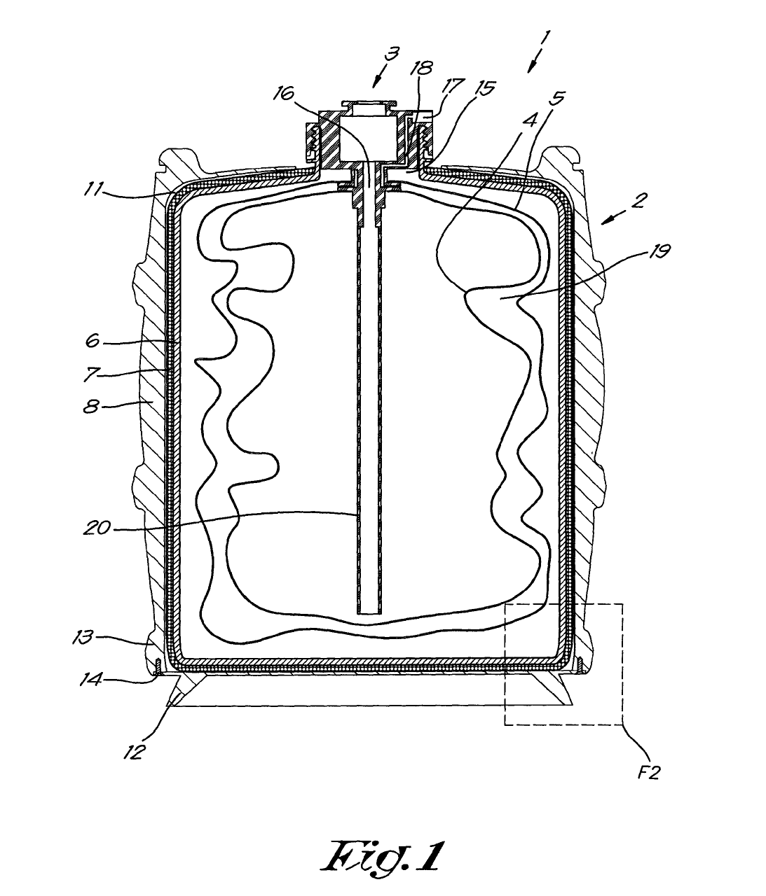

FIG. 1 shows a cross-section of a barrel according to the invention;

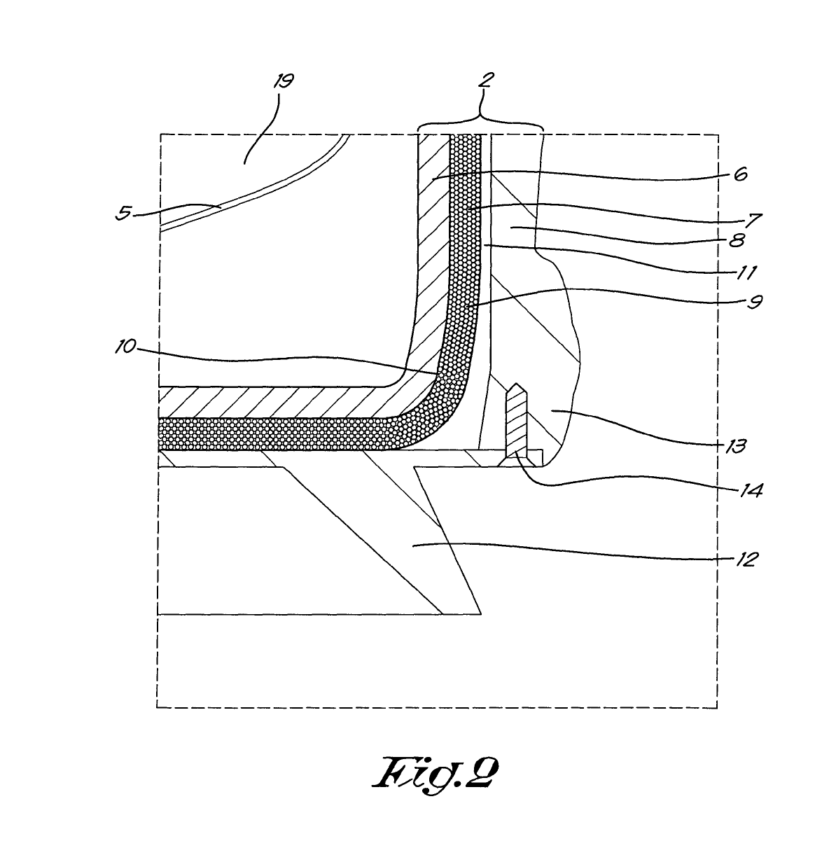

FIG. 2 shows the part of the barrel of FIG. 1 indicated by F2 on a larger scale; and

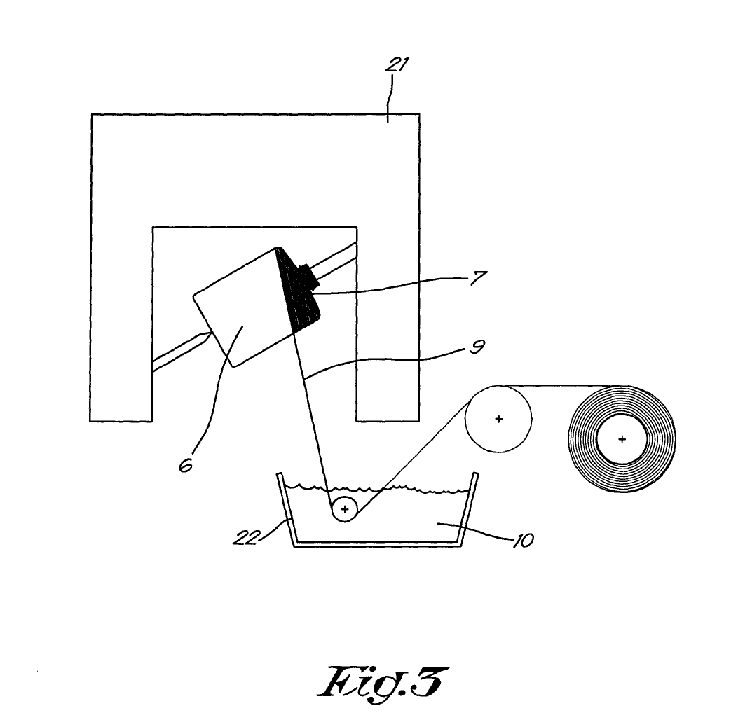

FIG. 3 shows a step in the production of the barrel of FIG. 1.

The barrel 1 shown in FIGS. 1 and 2 essentially consists of a rigid holder 2 and a connecting piece 3 affixed therein with two flexible holders 4,5.

The rigid holder 2 is made up of three layers, i.e. a first inner layer 6, a second middle layer 7 and a third outer layer 8.

The first layer 6 is made of high density polyethylene, HDPE, and has a thickness of approximately 3 mm. The second layer 7 is a composite layer, also with a thickness of approximately 3 mm, formed by a long glass fibre 9 that is wound around the first layer 6 and which is embedded in low density polyethylene, LDPE, 10. The second layer 7 is fused onto the first layer 6, such that these two layers 6,7 are attached together very firmly.

The third layer 8 is also made of HDPE and is relatively loosely affixed around the first layer 6 and second layer 7, so that there is some space 11 between the second layer 7 and the third layer 8. The third layer 8 consists of two parts, i.e. a base piece 12 and a top piece 13.

The base piece 12 and the top piece 13 are fastened together around the periphery by means of screws 14.

The rigid holder 2 has a first outlet 15 that is formed by the first layer 6, and which is provided with an external screw thread.

In this example, but not necessarily, the rigid holder 2 has an internal volume of 31 litres.

The connecting piece 3 is provided with two flexible holders, i.e. an inner flexible holder 4 and an outer flexible holder 5. The flexible holders 4,5 are each large enough to fill the space within the rigid holder 2.

The flexible holders 4, 5 are constructed as bags with a second outlet 16 to which the connecting piece 3 is fastened. The flexible holders 4, 5 are made of a multilayer foil with a metallised layer, in order to be impermeable to CO₂ and oxygen.

The connecting piece 3 is provided with an internal screw thread that fits on the external screw thread of the rigid holder 2, and with a connection 17 for a pressure medium source, in this example a CO₂ cylinder, whereby a channel 18 is provided from the connection 17 to the space 19 between the inner flexible holder 4 and the outer flexible holder 5.

A tube 20 is fastened to the connecting piece 3 that is located in the flexible holders 4,5. A tap can be mounted on top of the connecting piece 3.

The use of the barrel 1 of FIG. 1 is simple and as follows.

The barrel 1 is assembled by sliding the tube 20 and the two flexible holders 4,5 through the first outlet 15 and screwing the connecting piece 3 onto the first outlet 15 of the rigid holder 2.

Using a special filling head the inner flexible holder 4 can now be filled, via the connecting piece 3, with such a quantity of beer that the barrel 1 is practically completely filled, in this example with 30 litres of beer.

A long shelf life of the beer is now obtained because due to the low permeability to CO₂ and oxygen of the two flexible holders, no CO₂ can escape from the beer and no oxygen can diffuse from the outside air to the inside.

When the barrel 1 filled with beer has to be used, a CO₂ capsule is connected to the connection 17 provided to this end, so that CO₂ can flow into the space 19 between the inner flexible holder 4 and the outer flexible holder 5 and this space 19 can be placed under pressure. The outer flexible holder 5 is hereby pushed against the first layer 6 of the rigid holder 2. A tap is also affixed on the connecting piece 3.

When the tap is opened the beer flows to the outside due to the pressure applied by the tube 20.

When the barrel 1 is empty, the connecting piece 3 with the flexible holders 4,5 can be removed and destroyed. The combination of the connecting piece 3 and the flexible holders 4,5 is practically impossible to clean, so that reuse is not possible.

The remaining rigid 2 holder is inspected for damage. If the base piece 12 is damaged, it can easily be replaced by unscrewing the screws 14, affixing a new base piece 12 and tightening the screws 14 again.

If the top piece 13 is damaged it can be replaced in a similar way, whereby the first layer 6 and the second layer 7 can be slid out of the top piece 13 thanks to the space 11 that is between the second layer 7 and the top piece 13, and can be slid into a new top piece 13.

The rigid holder 2 can now be provided with a new connecting piece 3 with new flexible holders 4,5, and filled with beer again.

The rigid holder 2 can be produced as follows.

A separate holder 6, that will later form the first layer, is produced by injection moulding. The top piece 13 and the base piece 12 of the third layer 8 are also separately produced by means of injection moulding.

The said separate holder 6 is wrapped with glass fibre 9, by means of a winding machine 21, and this glass fibre 9 is first guided through a bath 22 of molten LDPE 10. This is shown in FIG. 3.

Hereby various layers of windings are placed crosswise in order to form together the second layer 7 of the rigid holder 2.

Due to the fact that the LDPE 10 on the glass fibre 9 is still molten when it is wound, a very good attachment is brought about between the separate holder 6 and the wound layer 7. Attention must be paid here to the positioning of the various components so that the distance between the bath 22 of molten LDPE 10 and the winding machine 22 is not so large that the LDPE 10 has already solidified when it is wound around the separate [holder].

As an alternative to molten LDPE 10, adhesive, resin and similar can be used to bring about a good attachment to the separate holder 6.

Then the wound separate holder, that is equivalent to the first layer 6 and the second layer 7, is slid in a top piece 13, after which the third layer is completed by affixing a base piece 12.

The present invention is by no means limited to the embodiment described as an example and shown in the drawings, but a barrel according to the invention can be realised in all kinds of forms and dimensions without departing from the scope of the invention.

1-17. (canceled)

18. Barrel for CO2-containing drinks, whereby the barrel (1) comprises a rigid holder (2) that comprises at least two layers, i.e. a first layer (6) that is made of a polymer and a second (7), fiber-reinforced, layer, whereby the second layer (7) is outside the first layer (6) and whereby the second layer (7) is attached to the first layer (6), wherein the first layer is produced by means of injection molding.

19. Barrel according to claim 18, wherein the barrel (2) also comprises a flexible holder (4,5) that is located in the rigid holder (2).

20. Barrel according to claim 19, wherein the rigid holder (2) comprises a first outlet (15) and that the flexible holder comprises a second outlet, whereby the second outlet is provided with a connecting piece (3) that is connected to the first outlet and whereby the connecting piece (3) is also provided with a tap or a connection for a tap.

21. Barrel according to claim 18, wherein the first layer (6) is made of an injection-moldable polymer.

22. Barrel according to claim 18, wherein the second layer (7) is a glass-fiber reinforced layer.

23. Barrel according to claim 18, wherein the second layer (7) is provided with one or more reinforcing fibers are wound around the first layer (6).

24. Barrel according to claim 23, wherein the reinforcing fibers are embedded in a binder, whereby the binder is polypropylene or polyethylene.

25. Barrel according to claim 18, further comprising a barrier layer to prevent the diffusion of oxygen from the outside to the inside and the diffusion of CO2 from the inside to the outside.

26. Barrel according to claim 18, wherein the barrel has a content that is between 1 and 50 litres, and between 3 and 40 litres.

27. The barrel according to claim 18, wherein the barrel contains CO2-containing drinks, such as beer.

28. Barrel according to claim 19, wherein the first layer (6) is made of an injection-mouldable polymer.

29. Barrel according to claim 20, wherein the first layer (6) is made of an injection-mouldable polymer.

30. The barrel of claim 21, wherein the injection-mouldable polymer is polyethylene or polypropylene.

31. Barrel according to claim 19, wherein the second layer (7) is a glass-fibre reinforced layer.

32. Barrel according to claim 20, wherein the second layer (7) is a glass-fibre reinforced layer.

33. Barrel according to claim 21, wherein the second layer (7) is a glass-fibre reinforced layer.

34. Barrel according to claim 19, wherein the second layer (7) is provided with one or more reinforcing fibres are wound around the first layer (6).

35. Barrel according to claim 20, wherein the second layer (7) is provided with one or more reinforcing fibres are wound around the first layer (6).

36. Barrel according to claim 21, wherein the second layer (7) is provided with one or more reinforcing fibres are wound around the first layer (6).

37. Barrel according to claim 22, wherein the second layer (7) is provided with one or more reinforcing fibres are wound around the first layer (6).
